(19) United States
(12) Patent Application Publication
(10) Pub. No.: US 2026/0359610 A1
(43) Pub. Date: Nov. 12, 2026

(54) PREPROCESSING DEVICE, INFERENCE PROCESSING DEVICE, PREPROCESSING METHOD, AND INFERENCE PROCESSING METHOD

(71) Applicant: NTT, INC., Tokyo (JP)

(72) Inventors: Yuya OMORI, Musashino-shi, Tokyo (JP); Daisuke KOBAYASHI, Musashino-shi, Tokyo (JP); Ken NAKAMURA, Musashino-shi, Tokyo (JP); Yusuke HORISHITA, Musashino-shi, Tokyo (JP); Hiroyuki UZAWA, Musashino-shi, Tokyo (JP); Shuhei YOSHIDA, Musashino-shi, Tokyo (JP); Saki HATTA, Musashino-shi, Tokyo (JP); Yuko IINUMA, Musashino-shi, Tokyo (JP)

(73) Assignee: NTT, INC., Tokyo (JP)

(21) Appl. No.: 19/141,358

(22) PCT Filed: Jan. 19, 2023
(86) PCT No.: PCT/JP2023/001589

§ 371 Date: Jun. 20, 2025

(51) Int. Cl. G06N 3/0464

(52) U.S. Cl. CPC G06N 3/0464

(57) ABSTRACT

Provided is a pre-processing apparatus for inference using a CNN including transferring kernel data from an external memory, and decoding the transferred kernel data before use, and the pre-processing apparatus: estimates a convolution processing time based on a feature map size for each combination of the plurality of compression methods and the compression unit having different compression rates or different decoding times; estimates an external memory transfer time of the kernel data based on the compression rate for each combination; estimates a decoding time of the kernel data based on a decoding time per unit amount of the compression method for each combination; and determines whether or not to perform compression for each compression unit and a compression method to be used in a case where compression is to be performed, based on the estimated convolution processing time, the estimated external memory transfer time, and the estimated decoding time.

### TECHNICAL FIELD

The disclosed technology relates to a pre-processing apparatus, an inference processing apparatus, a pre-processing method, and an inference processing method.

### BACKGROUND ART

In inference processing of a convolutional neural network (CNN), a network model is composed of a plurality of layers, and convolution processing is performed in a convolutional layer. The convolution processing takes, as inputs, feature map data from the previous layer, etc., and kernel data, which is a weighting coefficient. A bias value is added to the product-sum operation performed with the input feature map and the kernel, and activation function processing is performed to obtain output feature map data. Convolution operations account for the majority of the operations in CNN inference processing.

In general, in a CNN, the data size of the kernel data of the network model is often large. In particular, when trying to implement and process CNN inference using dedicated hardware such as a large scale integration (LSI) or a field-programmable gate array (FPGA), the amount of internal memory such as a static random access memory (SRAM) inside the hardware is often limited due to constraints such as circuit scale, chip size, and power. In such a case, it is not possible to load all the kernel data onto the internal memory of the hardware for CNN inference at once due to limitations on the amount of internal memory.

For this reason, a method is often used in which the kernel data for all layers of the network model is stored in a large-capacity, low-speed, inexpensive external memory such as a double data rate synchronous dynamic random access memory (DDR-SDRAM), and only the kernel data required for the most recent operation processing is transferred from the external memory as appropriate to an internal memory such as a small-capacity, high-speed, expensive SRAM.

For example, the kernel data for one layer is treated as a transfer unit, and each time convolution operation processing of one layer is completed, the kernel data of the next layer is transferred from the external memory to the internal memory, and the kernel data of the current layer, which has become temporarily unnecessary after the convolution operation processing is completed, is overwritten with the kernel data of the next layer. In this case, it is sufficient to store only the kernel data for one or two layers in the internal memory at any one time, and inference processing can be executed with a limited amount of internal memory.

On the other hand, if such a method is employed in which only the necessary kernel data is stored as appropriate in the internal memory, all kernel data will be transferred every time an inference result is obtained. In particular, in the case of a CNN, which processes a video, a large amount of data transfer is required per second “frame rate×all kernel data”. Therefore, this method reduces the amount of internal memory, but increases the transfer rate with the external memory.

In a case where the size of the kernel data is large, the transfer time from the external memory may be longer than the operation time of CNN inference hardware, particularly the convolution operation time, and in such a case, the operation circuit may have to wait for data transfer. This reduces the throughput and processing performance of the CNN inference hardware.

For this reason, the kernel data may be losslessly compressed using variable length coding or the like to reduce the data size and the amount of data required for transfer to and from an external memory (see, for example, NPL 1). This reduces the number of times that an operation unit such as a convolution operation circuit waits for kernel data, thereby improving processing performance.

In a case of implementing CNN inference in hardware, it is common to prepare circuits that process a product-sum operation unit and the like in parallel, and perform convolution operations simultaneously in relatively large groups. For example, a product-sum operation circuit capable of performing convolution processing on 32 output channels at once is prepared, and the 32 output channels are processed in sequence.

In the case of kernel compression, the compression unit is set to match the calculation unit, and whether or not to compress each compression unit is determined in advance before compression processing. In a case where a plurality of compression methods can be selected, the compression method to be used is also determined in advance for each compression unit before compression processing. The determination as to whether to compress and which compression method to use is made to minimize data size.

Then, the compressed data for all layers is stored in an external memory, and the compressed data for each layer is transferred from the outside and stored in the internal memory. The convolution operation circuit appropriately reads one unit of compressed data from the internal memory and decodes the compressed data before using the compressed data.

### CITATION LIST

### Non Patent Literature

[NPL 1] M. Asif Ali, et, “Lossless image compression using kernel based Global Structure Transform (GST)”, Proceedings—2010 6th International Conference on Emerging Technologies, ICET 2010. DOI:10.1109/ICET.2010.5638494

### SUMMARY OF INVENTION

### Technical Problem

On the other hand, since decoding kernel data also takes processing time, there may be cases where the convolution operation and external memory transfer are completed but the decoding processing is not completed, resulting in a wait. In particular, the convolution operation time is proportional to the size (width W, height H) of the feature map, while the decoding time is correlated not with the size (width W, height H) of the feature map but with the kernel size, that is, the number of input channels and the number of output channels. Therefore, in layers with small feature maps, the convolution operation is completed quickly, but the decoding of the kernel data takes time, just like in other layers, and the operation circuit often has to wait for the decoding.

Furthermore, in a case where an attempt is made to improve compression performance, a complex compression algorithm is used, which tends to lengthen the time required for a decoding circuit to decode the kernel data. Therefore, although the compression rate is high and the data transfer time is short, it takes time to decode the kernel data, which often results in waiting for the decoding.

As described above, kernel compression, which was originally proposed with the aim of reducing the latency of the operation circuit and the data transfer time, ends up in a situation where additional latency is generated for decoding the kernel compression.

For this reason, conventional methods that predetermine whether or not to compress and which compression method to use to minimize data size may not be effective in increasing the speed of CNN inference hardware and improving throughput.

The disclosed technology has been made in consideration of the above points, and aims to provide a pre-processing apparatus, an inference processing apparatus, a pre-processing method, and an inference processing method that can sufficiently obtain the effects of increasing speed and improving throughput.

### Solution to Problem

A first aspect of the present disclosure is a pre-processing apparatus for inference processing using a convolutional neural network including performing lossless compression on kernel data for each compression unit using one of a plurality of compression methods, pre-arranging the kernel data in an external memory, transferring the kernel data corresponding to a processing unit during the inference processing from the external memory, and decoding the transferred kernel data before use, and the pre-processing apparatus includes: a convolution processing time estimation unit configured to estimate a convolution processing time on the basis of a feature map size for each combination of the plurality of compression methods and the compression unit having different compression rates or different decoding times; an external memory transfer time estimation unit configured to estimate an external memory transfer time of the kernel data on the basis of the compression rate for each combination of the compression method and the compression unit; a decoding time estimation unit configured to estimate a decoding time of the kernel data on the basis of a decoding time per unit amount of the compression method for each combination of the compression method and the compression unit; and a determination unit configured to determine whether or not to perform compression for each compression unit and a compression method to be used in a case where compression is to be performed, on the basis of the estimated convolution processing time, the estimated external memory transfer time, and the estimated decoding time.

A second aspect is an inference processing apparatus for a convolutional neural network, inference processing using the convolutional neural network including performing lossless compression on kernel data for each compression unit using one of a plurality of compression methods, pre-arranging the kernel data in an external memory, transferring the kernel data corresponding to a processing unit during the inference processing from the external memory, and decoding the transferred kernel data before use, a convolution processing time is estimated on the basis of a feature map size for each combination of the plurality of compression methods and the compression unit having different compression rates or different decoding times, an external memory transfer time of the kernel data is estimated on the basis of the compression rate on the basis of a decoding time per unit amount of the compression method for each combination of the compression method and the compression unit, a decoding time of the kernel data is estimated for each combination of the compression method and the compression unit, and whether or not to perform compression for each compression unit and a compression method to be used in a case where compression is to be performed are determined on the basis of the estimated convolution processing time, the estimated external memory transfer time, and the estimated decoding time.

A third aspect is a pre-processing method for inference processing using a convolutional neural network including performing lossless compression on kernel data for each compression unit using one of a plurality of compression methods, pre-arranging the kernel data in an external memory, transferring the kernel data corresponding to a processing unit during the inference processing from the external memory, and decoding the transferred kernel data before use, and the pre-processing method includes: estimating, by a convolution processing time estimation unit, a convolution processing time on the basis of a feature map size for each combination of the plurality of compression methods and the compression unit having different compression rates or different decoding times; estimating, by an external memory transfer time estimation unit, an external memory transfer time of the kernel data on the basis of the compression rate for each combination of the compression method and the compression unit; estimating, by a decoding time estimation unit, a decoding time of the kernel data on the basis of a decoding time per unit amount of the compression method for each combination of the compression method and the compression unit; and determining, by a determination unit, whether or not to perform compression for each compression unit and a compression method to be used in a case where compression is to be performed, on the basis of the estimated convolution processing time, the estimated external memory transfer time, and the estimated decoding time.

A fourth aspect is an inference processing method for a convolutional neural network, inference processing using the convolutional neural network including performing lossless compression on kernel data for each compression unit using one of a plurality of compression methods, pre-arranging the kernel data in an external memory, transferring the kernel data corresponding to a processing unit during the inference processing from the external memory, and decoding the transferred kernel data before use, and the inference processing method includes: estimating a convolution processing time on the basis of a feature map size for each combination of the plurality of compression methods and the compression unit having different compression rates or different decoding times; estimating an external memory transfer time of the kernel data on the basis of the compression rate for each combination of the compression method and the compression unit; estimating a decoding time of the kernel data on the basis of a decoding time per unit amount of the compression method for each combination of the compression method and the compression unit; and determining whether or not to perform compression for each compression unit and a compression method to be used in a case where compression is to be performed, on the basis of the estimated convolution processing time, the estimated external memory transfer time, and the estimated decoding time.

### Advantageous Effects of Invention

According to the disclosed technology, the effects of increasing speed and improving throughput can be sufficiently obtained.

### BRIEF DESCRIPTION OF DRAWINGS

FIG. 1A is a configuration diagram illustrating an example of a hardware configuration of an inference processing apparatus according to an embodiment.

FIG. 1B is a configuration diagram illustrating an example of a hardware configuration of a pre-processing apparatus according to the embodiment.

FIG. 2 is a block diagram illustrating an example of a functional configuration of the pre-processing apparatus according to the embodiment.

FIG. 3 is a flowchart showing an example of determination processing in the pre-processing apparatus according to the embodiment.

FIG. 4 is a diagram illustrating CNN inference processing in the inference processing apparatus.

### DESCRIPTION OF EMBODIMENTS

An example of embodiments of the disclosed technology will be described below with reference to the drawings. The identical reference numerals are given to the identical or equivalent components and parts in each drawing. In addition, the dimensional ratios in the drawings are exaggerated for convenience of description and may differ from the actual ratios.

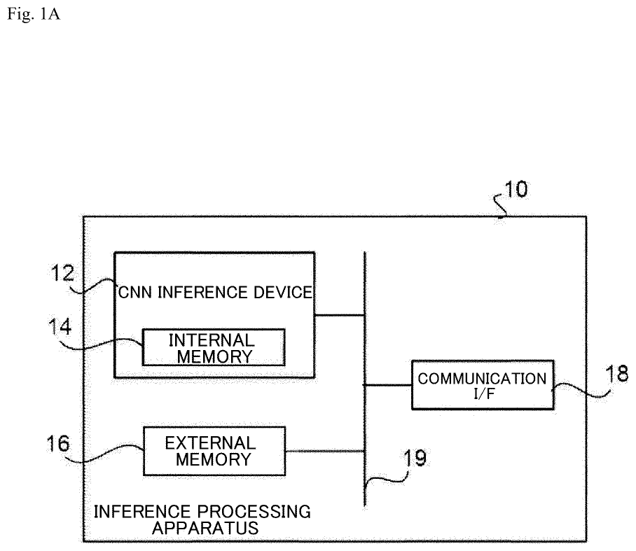

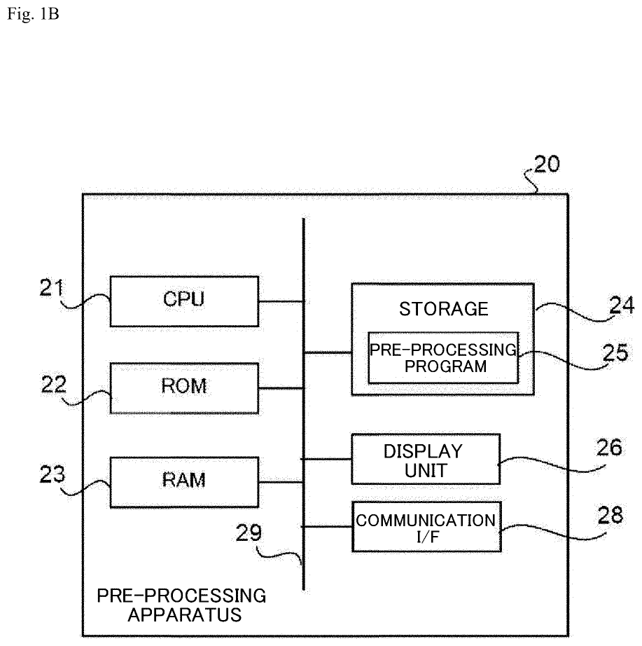

First, an example of a configuration of an inference processing apparatus 10 according to the technology of the present embodiment will be described. The inference processing apparatus 10 according to the present embodiment is a processing apparatus that executes inference processing using a convolutional neural network (CNN). FIG. 1A is a configuration diagram illustrating an example of a hardware configuration of the inference processing apparatus 10 according to the present embodiment. As illustrated in FIG. 1A, the inference processing apparatus 10 according to the present embodiment includes a CNN inference device 12, an external memory 16, and a communication interface (I/F) 18. The CNN inference device 12, the external memory 16, and the communication I/F 18 are communicatively connected to each other via a bus 19 such as a system bus or a control bus.

The CNN inference device 12 includes an internal memory 14 and is dedicated hardware for executing inference processing using a CNN model. Examples of the CNN inference device 12 include processors such as large scale integration (LSI) and a field-programmable gate array (FPGA).

An example of the CNN model is a CNN model that performs semantic segmentation. A CNN model is composed of, for example, an input layer, at least one convolution layer and a pooling layer, a fully connected layer, and an output layer. The model data of the CNN model is often stored in the external memory 16 together with the kernel data. In addition, the model data of the CNN may be stored in advance in a non-volatile storage unit built into the CNN inference device 12.

The internal memory 14 is a memory implemented in the CNN inference device 12, and may be a RAM such as a static random access memory (SRAM).

The external memory 16 is an external memory that is used when the CNN inference device 12 executes inference processing of the CNN model. The external memory 16 stores kernel data in the CNN model. In the present embodiment, kernel data that has been compressed or uncompressed through pre-processing, which will be described later, by the pre-processing apparatus 20 is stored in the external memory 16. Examples of external memory 16 include a double data rate synchronous dynamic random access memory (DDR-SDRAM).

The communication I/F 18 is an interface for communicating with external devices, and uses standards such as Ethernet (registered trademark), FDDI, and Wi-Fi (registered trademark). The communication I/F 18 is used for transferring kernel data and the like.

Next, an example of the configuration of the pre-processing apparatus 20 according to the technology of the present embodiment will be described. The pre-processing apparatus 20 according to the present embodiment is a processing apparatus that, before the CNN inference device 12 of the inference processing apparatus 10 executes inference processing using the CNN model (in advance), determines whether or not to compress the kernel data transferred from the external memory 16 to the internal memory 14 and a compression method to be used in a case where compression is to be performed, to minimize the inference processing time of the CNN model. For example, a so-called general-purpose personal computer can be used as the pre-processing apparatus 20. FIG. 1B is a configuration diagram illustrating an example of a hardware configuration of the pre-processing apparatus 20 according to the present embodiment. As illustrated in FIG. 1B, the pre-processing apparatus 20 according to the present embodiment includes a central processing unit (CPU) 21, a read only memory (ROM) 22, a random access memory (RAM) 23, a storage 24, a display unit 26, and a communication I/F 28. Each component is communicatively connected to each other via a bus 29 such as a system bus or a control bus.

The CPU 21 is a central processing unit, and executes various programs such as a pre-processing program 25 stored in the storage 24, and controls each unit.

The ROM 22 stores various programs executed by the CPU 21 and various types of data. The RAM 23 also serves as a work area when the CPU 21 executes various programs, and temporarily stores programs or data. That is, the CPU 21 reads the programs from the storage 24 and executes the programs by using the RAM 23 as a work area.

In the present embodiment, the storage 24 stores the pre-processing program 25. The pre-processing program 25 may be one program, or may be a program group including a plurality of programs or modules. Examples of the storage 25 include a hard disk drive (HDD) or a solid state drive (SSD).

The display unit 26 is for displaying various types of information. The display unit 26 is not particularly limited, and various types of displays can be used. Moreover, the display unit 26 may be a touch panel display having a function as an input device for a user. The communication I/F 28 is an interface for communicating with external devices, and uses standards such as Ethernet (registered trademark), FDDI, and Wi-Fi (registered trademark).

Next, a functional configuration related to a pre-processing function that the pre-processing apparatus 20 performs in advance to minimize the inference processing time before the CNN inference device 12 of the inference processing apparatus 10 performs inference processing using a CNN model will be described.

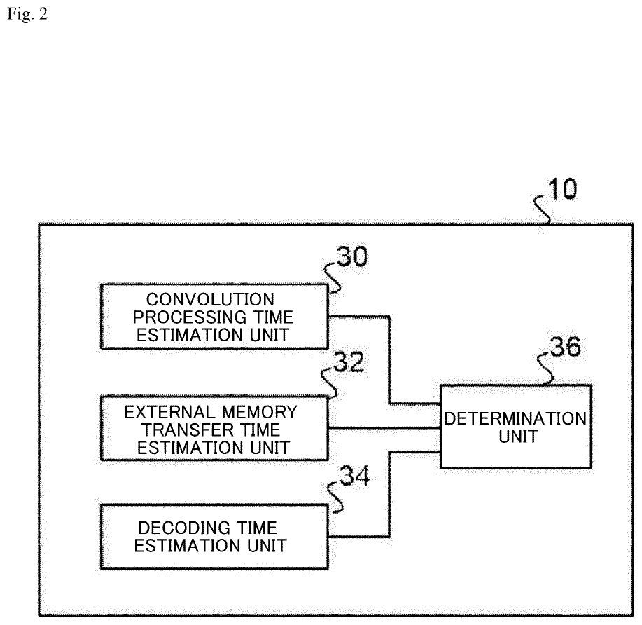

As illustrated in FIG. 2, the pre-processing apparatus 20 according to the present embodiment includes a convolution processing time estimation unit 30, an external memory transfer time estimation unit 32, a decoding time estimation unit 34, and a determination unit 36. By the pre-processing apparatus 20 executing the pre-processing program 25 stored in the storage 24, the pre-processing apparatus 20 functions as the convolution processing time estimation unit 30, the external memory transfer time estimation unit 32, the decoding time estimation unit 34, and the determination unit 36.

In compressing kernel data, there are I selectable compression methods, where i (0≤i≤I) is a compression method, i=0 means no compression, 0≤i≤I means compression, and the compression unit is defined using the number of output channels x and the number of input channels y. In addition, it is assumed that the convolution operation unit of the CNN model has a circuit configuration that can simultaneously process x output channels [och], and the convolution operation unit has a circuit configuration that can simultaneously process product-sum operations of a size of width w×height h per channel in one clock.

The compression unit of the kernel is made to match the unit of the convolution operation. That is, x output channels are grouped together into one compression unit. In a case where there are a total of J compression units, J=number of output channels och÷x is satisfied. The unit number of the compression unit is defined as unit j (0≤j≤J−1).

The convolution processing time estimation unit 30 has a function of estimating a convolution processing time Aij required for the convolution processing of one compression unit.

The convolution processing time Aij[clk], in the absence of operation skips, is the time required for convolution processing, which is the product of the feature map size (width W×height H), the kernel size (k×k), the number of output channels x, and the number of input channels y. Since the number of output channels in one unit is x, the number of required product-sum operations is W×H×k×k×x×y (times). If the number of product-sum operations that can be performed per clock [clk] is N, the convolution processing time Aij is obtained by the following Equation (1).

Aij=k×k×x×y×W×H÷N[clk] (1)

In this way, the convolution processing time Aij does not depend on the compression method i, but is proportional to the size (W×H) of the feature map of the current layer.

The external memory transfer time estimation unit 32 has a function of estimating an external memory transfer time Bij of kernel data for one compression unit. The kernel data is determined during training of the CNN model and is known before the inference processing of the CNN model begins. Therefore, it is possible to compress the kernel data in advance, and the compression rate can be obtained in advance.

The compression rate when compression unit j is compressed by the compression method i is defined as Rij (0<Rij≤1). In a case where no compression is represented by i=0, in other words, in the case of a compression method 0, R0j=1 is satisfied regardless of the compression unit j. If the size of each piece of kernel data is b [bits], the data size of one compression unit when the data is not compressed is (k×k)×x×y×b [bits].

The size of kernel data in one compression unit is Rij×k×k×x×y×b [bits].

If an average transfer rate to the external memory 16 is m [bit/clk], the external memory transfer time Bij is obtained by the following Equation (2).

Bij=Rij×k×k×x×y×b÷m[clk] (2)

In this way, the external memory transfer time Bij does not depend on the size (W×H) of the feature map of the current layer. Also, unlike feature map data, the results of which change with each inference, kernel data is uniquely known in advance, so that the required number of transfer clocks can be estimated in advance, including the compression rate Rij.

The decoding time estimation unit 34 has a function of estimating a decoding time Cij of kernel data for one compression unit. A convolution operation circuit is usually configured to output the same amount of uncompressed data for each clock, so that when the same compression method is used, it is assumed that the decoding time will be proportional to the uncompressed data size.

The amount of decoding time required for each compression method depends on the type of decoding circuit that the CNN model implements and uses. When the compression method i compresses the compression unit j, a decoding time estimated to be required to decode a unit amount (1 bit) is defined as Dij.

Generally, the compression method requiring a longer decoding time often has a higher compression rate performance. In other words, it can be said that the decoding time Dij and the compression rate Rij have a negative correlation. The decoding time Dij can be estimated in advance. For example, the time taken by the decoding circuit to perform decoding using the compression method i may be measured in various cases, and the average time may be used. In this case, the average decoding time depends only on the compression method i, and the decoding time Dij becomes constant regardless of the compression unit j, which simplifies the calculation. Alternatively, taking into account the compression method i and the circuit configuration, it is possible to determine how the circuit will operate to decode the current compression unit j, and to estimate in advance the detailed decoding time Dij for each compression unit j.

In addition, since no decoding time is required when the data is not compressed, the decoding time D0j=0 is satisfied.

Since the uncompressed data size is (k×k)×x×y [bits] and the decoding time per bit is Dij, the decoding time Cij is obtained by the following Equation (3).

Cij=Di×k×k×x×y×b[clk] (3)

In this way, the decoding time Cij does not depend on the size (W×H) of the feature map of the current layer. Furthermore, by taking into consideration advance measurements and the configuration of the decoding circuit, it is possible to measure the time required for decoding in advance.

The determination unit 36 has a function of determining whether or not to perform compression for each compression unit j and a compression method to be used in a case where compression is to be performed, to minimize the inference processing time of the convolutional neural network, on the basis of the convolution processing time Aij estimated by the convolution processing time estimation unit 30, the external memory transfer time Bij estimated by the external memory transfer time estimation unit 32, and the decoding time Cij estimated by the decoding time estimation unit 34.

An inference processing time finally required in a case where the compression method i is used in the compression unit j is defined as Tij. The inference processing time Tij is determined by the longest of the convolution processing time Aij, the external memory transfer time Bij, and the decoding time Cij, and is therefore obtained by the following equation (4).

Tij=Max(Aij,Bij,Cij) (4)

The determination unit 36 determines, for each compression unit j, the compression method i that minimizes the inference processing time Tij. In other words, the determination unit 36 determines which compression method i minimizes the time required to process the compression unit j. That is, j that satisfies the following range (5) is determined.

$$[ Math . 1 ]$$

$${minimize}_{j} max ( {A}_{ij} , {B}_{ij} , {C}_{ij} ) = {minimize}_{j} max ( \text{} \frac{W \times H \times k \times k \times ich}{w \times h} , \frac{{R}_{ij} \times k \times k \times c \times ich \times b}{m} , {D}_{ij} \times k \times k \times c \times ich \times b ) \qquad ( 5 )$$

In this manner, the determination unit 36 of the pre-processing apparatus 20 determines, for each compression unit j, whether or not to compress the kernel data, and in a case of performing compression, the compression method i to be used.

In the present embodiment, before the CNN inference device 12 of the inference processing apparatus 10 executes inference processing using the CNN model (in advance), the kernel data of the CNN model is stored in the external memory 16 of the inference processing apparatus 10 according to whether or not to perform compression for each compression unit i and the compression method i, as determined by the pre-processing apparatus 20. Specifically, for the compression unit i that has been determined not to be compressed, the data is transferred to the inference processing apparatus 10 via the communication I/F 18 in an uncompressed state and stored in the external memory 16. In addition, for the compression unit i that has been determined to be compressed, the data is transferred to the inference processing apparatus 10 via the communication I/F 18 in a losslessly compressed state using the determined compression method i, and stored in the external memory 16. The compression processing of the kernel data may be performed by any apparatus.

Next, the operation of the pre-processing function of the pre-processing apparatus 20 according to the present embodiment will be described.

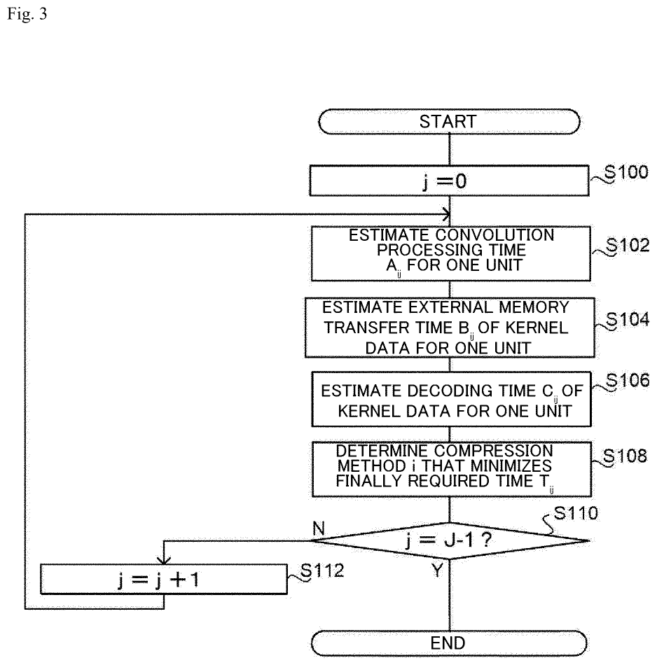

FIG. 3 shows a flowchart of an example of pre-processing for determining the inference processing time Tij, which is executed by the pre-processing apparatus 20 according to the present embodiment. The pre-processing apparatus 20 according to the present embodiment executes the pre-processing shown in FIG. 3 at any timing before the CNN inference device 12 of the inference processing apparatus 10 executes the inference processing using the CNN model.

In step S100 shown in FIG. 3, the determination unit 36 sets the compression number j=0.

In the next step S102, the convolution processing time estimation unit 30 estimates, for each compression method i, the convolution processing time Aij for one compression unit in the combination of the compression method i and the compression unit j, as described above.

In the next step S104, the external memory transfer time estimation unit 32 estimates, for each compression method i, the external memory transfer time Bij of kernel data for one compression unit in the combination of the compression method i and the compression unit j, as described above.

In the next step S106, the decoding time estimation unit 34 estimates, for each compression method i, the decoding time Cij of kernel data for one compression unit in the combination of the compression method i and the compression unit j, as described above.

The order in which steps S102 to S106 are executed does not matter. In addition, some or all of the processes in steps S102 to S106 may be executed in parallel.

In the next step S108, the determination unit 36 determines a compression method i that minimizes the finally required inference processing time Tij for the compression unit j on the basis of the convolution processing time Aij, the external memory transfer time Bij, and the decoding time Cij, as described above.

In the next step S110, the determination unit 36 determines whether or not the compression number j is J−1. In a case where the compression number j is not J−1, the determination in step S110 is negative, and the process proceeds to step S112.

After the compression number j is incremented (j=j+1) in step S112, the process returns to step S102, and the processes of steps S102 to S110 are repeated to determine the compression method i for the next compression number j.

On the other hand, in a case where the compression number j is J−1, the determination in step S110 is affirmative, and the pre-processing shown in FIG. 3 ends.

When the pre-processing in the pre-processing apparatus 20 ends in this manner, as described above, the kernel data is stored in the external memory 16 of the inference processing apparatus 10 in a compressed or uncompressed state for each compression unit i depending on the pre-result.

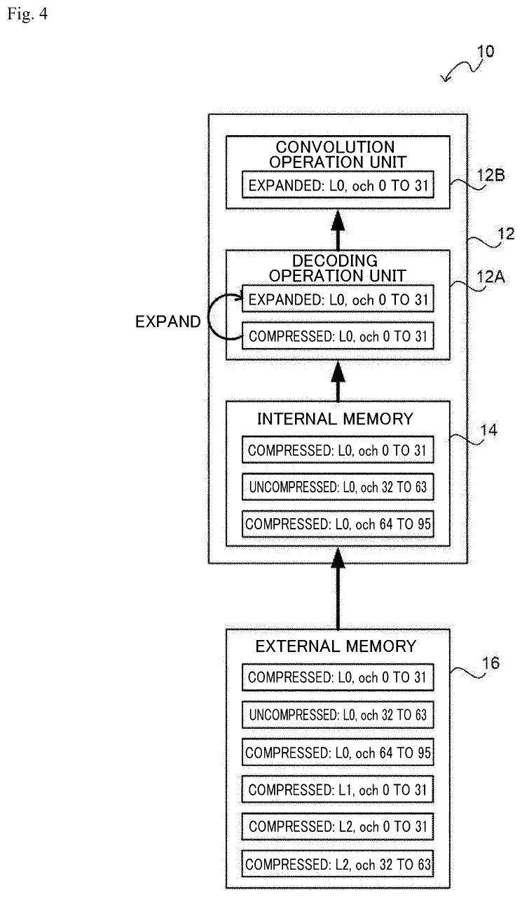

Then, the inference processing apparatus 10 according to the present embodiment executes inference processing of the CNN model by the CNN inference device 12 in a state in which the compressed or uncompressed kernel data for each compression unit i is stored in the external memory 16 (see FIG. 4). The inference processing apparatus 10 in FIG. 4 shows a three-layer network in which the compression unit i has 32 channels. In the example shown in FIG. 4, a first layer (L0) has 96 channels, with channels 0 to 31 (och) being stored in a compressed state, channels 32 to 63 (och) being stored in an uncompressed state, and channels 64 to 95 (och) being stored in a compressed state in the external memory 16. A second layer (L1) has 32 channels, with channels 0 to 31 (och) being stored in a compressed state in the external memory 16. Furthermore, a third layer (L3) has 64 channels, with channels 0 to 31 (och) being stored in a compressed state, and channels 32 to 63 (och) also being stored in a compressed state in the external memory 16.

As shown in FIG. 4, when performing inference processing of a CNN model, the CNN inference device 12 transfers kernel data required for each processing unit from the external memory 16 to the internal memory 14, a decoding operation unit 12A decodes (expands) the kernel data stored in the internal memory 14, and a convolution operation unit 12B performs convolution processing using the decoded (expanded) kernel data.

In this way, according to this method, by selecting the compression method i that minimizes the inference processing time Tij for each compression unit j, it is possible to achieve high speed processing that takes into account all of the convolution processing time Aij, the external memory transfer time Bij, and the decoding time Cij. Therefore, with the pre-processing apparatus 20 according to the present embodiment, it is possible to determine a compression method that maximizes the throughput of the CNN inference device 12 of the inference processing apparatus 10. In other words, with the inference processing apparatus 10 according to the present embodiment, the throughput of the inference processing by the CNN inference device 12 can be maximized.

In the above embodiment, the inference processing apparatus 10 and the pre-processing apparatus 20 are configured as separate apparatuses. However, they may be configured as a single apparatus having the functions of the inference processing apparatus 10 and the pre-processing apparatus 20. In this case, for example, the CNN inference device 12 of the inference processing apparatus 10 may perform the pre-processing.

Furthermore, the specific configurations of the inference processing apparatus 10 and the pre-processing apparatus 20 described above are also merely examples, and the specific configuration is not important as long as the above-mentioned functions are provided. For example, the inference processing apparatus 10 may include at least one of other components such as a processor, a storage, a display unit, and a communication I/F.

Furthermore, the pre-processing performed by the pre-processing apparatus 20 may be executed by various processors other than the pre-processing apparatus 20. Examples of processors used in such cases include a programmable logic device (PLD) such as an FPGA of which a circuit configuration can be changed after manufacturing and a dedicated electrical circuit that is a processor having a circuit configuration such as an application specific integrated circuit (ASIC) that is dedicatedly designed to execute specific processing. It may also be a CPU or the like. In addition, pre-processing may be executed by one of these various processors, or may be executed by a combination of two or more processors of the same type or different types (for example, a combination of a plurality of FPGAs, a combination of a CPU and an FPGA, and the like). More specifically, a hardware structure of the various processors is an electrical circuit in which circuit elements such as semiconductor elements are combined.

While an aspect in which the pre-processing program 25 is stored (installed) in advance in the storage 24 has been described in each of the embodiments, the present disclosure is not limited thereto. Each of the pre-processing program 25 may be provided in a form stored in a non-transitory storage medium such as a compact disk read only memory (CD-ROM), a digital versatile disc read only memory (DVD-ROM), and a Universal Serial Bus (USB) memory. Further, the pre-processing program 25 may be downloaded from an external device via a network.

Regarding the above embodiment, the following supplementary notes are further disclosed.

### (Supplementary Note 1)

A pre-processing apparatus for inference processing using a convolutional neural network including performing lossless compression on kernel data for each compression unit using one of a plurality of compression methods, pre-arranging the kernel data in an external memory, transferring the kernel data corresponding to a processing unit during the inference processing from the external memory, and decoding the transferred kernel data before use, the pre-processing apparatus including:
a memory; and
at least one processor connected to the memory,
in which the processor is configured to:
estimate a convolution processing time on the basis of a feature map size for each combination of the plurality of compression methods and the compression unit having different compression rates or different decoding times;
estimate an external memory transfer time of the kernel data on the basis of the compression rate for each combination of the compression method and the compression unit;
estimate a decoding time of the kernel data on the basis of a decoding time per unit amount of the compression method for each combination of the compression method and the compression unit; and
determine whether or not to perform compression for each compression unit and a compression method to be used in a case where compression is to be performed, on the basis of the estimated convolution processing time, the estimated external memory transfer time, and the estimated decoding time.

### (Supplementary Note 2)

A non-transitory storage medium storing a pre-processing program that causes a computer to execute pre-processing of inference processing using a convolutional neural network, the inference processing including performing lossless compression on kernel data for each compression unit using one of a plurality of compression methods, pre-arranging the kernel data in an external memory, transferring the kernel data corresponding to a processing unit during the inference processing from the external memory, and decoding the transferred kernel data before use,
in which the pre-processing includes:
estimating a convolution processing time on the basis of a feature map size for each combination of the plurality of compression methods and the compression unit having different compression rates or different decoding times;
estimating an external memory transfer time of the kernel data on the basis of the compression rate for each combination of the compression method and the compression unit;
estimating a decoding time of the kernel data on the basis of a decoding time per unit amount of the compression method for each combination of the compression method and the compression unit; and
determining whether or not to perform compression for each compression unit and a compression method to be used in a case where compression is to be performed, on the basis of the estimated convolution processing time, the estimated external memory transfer time, and the estimated decoding time.

### REFERENCE SIGNS LIST

10 Inference processing apparatus
12 CNN inference device
12A Decoding operation unit
12B Convolution operation unit
14 Internal memory
16 External memory
20 Pre-processing apparatus
21 CPU
24 Storage
25 Pre-processing program
30 Convolution processing time estimation unit
32 External memory transfer time estimation unit
34 Decoding time estimation unit
36 Determination unit

1. A pre-processing apparatus for inference processing using a convolutional neural network, the pre-processing apparatus comprising:
a memory; and
a processor coupled with the memory, the processor being configured to:
perform lossless compression on kernel data for each compression unit using one of a plurality of compression methods, pre-arrange the kernel data in an external memory, transfer the kernel data corresponding to a processing unit during the inference processing from the external memory, and decode the transferred kernel data before use,
wherein the processor is further configured to: estimate a convolution processing time on the basis of a feature map size for each combination of the plurality of compression methods and the compression unit having different compression rates or different decoding times;
estimate an external memory transfer time of the kernel data on the basis of the compression rate for each combination of the compression method and the compression unit;
estimate a decoding time of the kernel data on the basis of a decoding time per unit amount of the compression method for each combination of the compression method and the compression unit; and
determine whether or not to perform compression for each compression unit and a compression method to be used in a case where compression is to be performed, on the basis of the estimated convolution processing time, the estimated external memory transfer time, and the estimated decoding time.

2. The pre-processing apparatus according to claim 1, wherein when the compression unit is defined using the number of output channels x and the number of input channels y, a compression method is i (i=0: no compression, i=1 or more: compression), a kernel compression unit number is j, a feature map size is width W×height H, a kernel size is k×k, and the number of product-sum operations that can be performed per clock [clk] is N, a convolution processing time Aij required for convolution processing of one compression unit, which is estimated by the processor, is expressed as
Aij=k×k×x×y×W×H÷N[clk],
when a compression rate Rij is obtained by a preliminary trial and i=0 indicates no compression, R0j=1 is satisfied,
when a size of each piece of kernel data is expressed as b [bit], the size of the kernel data in one compression unit is expressed as
Rij×k×k×x×y×b[bit],
when an average transfer rate to the external memory is m [bit/clk],
the external memory transfer time Bij of the kernel data for one compression unit, which is estimated by the processor, is expressed as
Bij=Rij×k×k×x×y×b÷m[clk],
when an average decoding time per bit is Di [clk] (D0=0), a decoding time Cij of the kernel data for one compression unit, which is estimated by the processor, is expressed as
Cij=Di×k×k×x×y×b[clk],
an inference processing time Tij finally required in a case where the compression method i is used in the compression unit j is expressed as
Tij=Max(Aij,Bij,Cij), and
the processor determines, for each compression unit j, the compression method i that minimizes the inference processing time Tij.

3. The pre-processing apparatus according to claim 1, wherein the determination performed by the processor is made prior to the inference processing of the convolutional neural network.

4. An inference processing apparatus for a convolutional neural network, the inference processing apparatus comprising:
a memory; and
a processor coupled with the memory, the processor being configured to perform inference processing using the convolutional neural network, the inference processing comprising:
performing lossless compression on kernel data for each compression unit using one of a plurality of compression methods, pre-arranging the kernel data in an external memory, transferring the kernel data corresponding to a processing unit during the inference processing from the external memory, and decoding the transferred kernel data before use, wherein the processor is further configured to:
estimate a convolution processing time on the basis of a feature map size for each combination of the plurality of compression methods and the compression unit having different compression rates or different decoding times,
estimate an external memory transfer time of the kernel data on the basis of the compression rate for each combination of the compression method and the compression unit,
estimate a decoding time of the kernel data on the basis of a decoding time per unit amount of the compression method for each combination of the compression method and the compression unit, and
determine whether or not to perform compression for each compression unit and a compression method to be used in a case where compression is to be performed on the basis of the estimated convolution processing time, the estimated external memory transfer time, and the estimated decoding time.

5. A pre-processing method for inference processing using a convolutional neural network, the pre-processing method comprising:
performing, by a processor, lossless compression on kernel data for each compression unit using one of a plurality of compression methods, pre-arranging the kernel data in an external memory, transferring the kernel data corresponding to a processing unit during the inference processing from the external memory, and decoding the transferred kernel data before use;
estimating, by the processor, a convolution processing time on the basis of a feature map size for each combination of the plurality of compression methods and the compression unit having different compression rates or different decoding times;
estimating, by the processor, an external memory transfer time of the kernel data on the basis of the compression rate for each combination of the compression method and the compression unit;
estimating, by the processor, a decoding time of the kernel data on the basis of a decoding time per unit amount of the compression method for each combination of the compression method and the compression unit; and
determining, by the processor, whether or not to perform compression for each compression unit and a compression method to be used in a case where compression is to be performed, on the basis of the estimated convolution processing time, the estimated external memory transfer time, and the estimated decoding time.

6. The pre-processing method according to claim 5, wherein when the compression unit is defined using the number of output channels x and the number of input channels y, a compression method is i (i=0: no compression, i=1 or more: compression), a kernel compression unit number is j, a feature map size is width W×height H, a kernel size is k×k, and the number of product-sum operations that can be performed per clock [clk] is N, a convolution processing time Aij required for convolution processing of one compression unit, which is estimated by the processor, is expressed as
Aij=k×k×x×y×W×H÷N[clk],
when a compression rate Rij is obtained by a preliminary trial and i=0 indicates no compression, R0j=1 is satisfied, when a size of each piece of kernel data is expressed as b [bit], the size of the kernel data in one compression unit is expressed as
Rij×k×k×x×y×b[bit],
when an average transfer rate to the external memory is m [bit/clk],
the external memory transfer time Bij of the kernel data for one compression unit, which is estimated by the processor, is expressed as
Bij=Rij×k×k×x×y×b÷m[clk],
when an average decoding time per bit is Di [clk] (D0=0), a decoding time Cij of the kernel data for one compression unit, which is estimated by the processor, is expressed as
Cij=Di×k×k×x×y×b[clk],
an inference processing time Tij finally required in a case where the compression method i is used in the compression unit j is expressed as
Tij=Max(Aij,Bij,Cij), and
the processor determines, for each compression unit j, the compression method i that minimizes the inference processing time Tij.

7. (canceled)
